(19) United States
(12) Patent Application Publication
(10) Pub. No.: US 2026/0316111 A1
(43) Pub. Date: Oct. 15, 2026

(54) PRECISE MICROMETER LEVEL GLUE FILM COATING APPLICATION

(71) Applicant: NORDSON CORPORATION, WESTLAKE, OH (US)

(72) Inventors: Peter QIU, Shanghai (CN); Neil REN, Shanghai (CN)

(73) Assignee: NORDSON CORPORATION, WESTLAKE, OH (US)

(21) Appl. No.: 19/483,643

(22) PCT Filed: May 17, 2024
(86) PCT No.: PCT/CN2024/093876

§ 371 Date: Nov. 12, 2025

(30) Foreign Application Priority Data
May 19, 2023 (CN) 202321230351.2

(51) Int. Cl. B05C 5/02; B05C 5/00; B05C 11/10

(52) U.S. Cl. CPC B05C 5/0225; B05C 5/001; B05C 5/0258; B05C 11/1002

(57) ABSTRACT

The present application relates to a nozzle assembly and a coating system comprising the same. The nozzle assembly (5) comprises: a lip plate (51) that has a lip plate channel (51a) extending through the lip plate in a thickness direction of the lip plate and a receiving groove (51b) located on one side of the lip plate in the thickness direction and used for receiving a fluid from outside of the nozzle assembly, the lip plate channel (51a) and the receiving groove (51b) being in fluid communication with each other; a cover plate (52) that is connected to the lip plate on the other side of the lip plate (51) opposite to the receiving groove (51b); and a shim (53) that is located between the lip plate and the cover plate, wherein the shim has a cutout (53a) extending upwards from a bottom side of the shim, and a height of a topmost portion of the cutout is greater than or equal to a height of a topmost portion of the lip plate channel of the lip plate.

### CROSS-REFERENCE TO RELATED APPLICATIONS

This application is a National Stage Application of International Patent App. No. PCT/CN2024/093876, filed May 17, 2024, which claims priority to Chinese Patent Application No. 202321230351.2, filed May 19, 2023, the entire disclosures of both of which are hereby incorporated by reference as if set forth in their entirety herein.

### TECHNICAL FIELD

The present application relates to a nozzle assembly and a coating system comprising the same.

### BACKGROUND ART

Electric vehicles represent a development direction for current automotive technology. Driving range is an important parameter for characterizing the performance of electric vehicles. The driving range depends, in part, on the performance of electric vehicle batteries. With the development of new processes for automotive batteries, the batteries of electric vehicles, especially blade batteries, need to be coated with very thin adhesive materials on part of their surfaces. Generally, it is required that a thermal adhesive material larger than 5 mm (width) and less than 20 μm (thickness) be evenly coated on the electrode sheets of their batteries, which is of great significance for enhancing the reliability of automotive batteries. The hot adhesive must be wrapped very thinly and evenly around the top surfaces of the electrode sheets, and coating defects such as missing adhesive or uneven application are not allowed. Moreover, in accordance with the strict standards for electrode manufacturing, there is zero tolerance for exposing metals that should be coated with glue to the atmosphere. In addition, the start/stop function is definitely a mandatory requirement for continuous coating performance. As always, hammerhead and coating breakage faults must be completely avoided. This clearly poses a severe challenge for the existing products.

It is known that seam welding machines are used in the manufacturing of positive and negative electrodes for electric vehicle batteries, requiring relatively high production line speeds (up to 120 m/min) or high hot-melt adhesive film coating speeds to replace the traditional adhesive tape bonding processes. However, the current methods and products fail to achieve a uniform adhesive thickness of 10-20 μm on the electrode sheets.

Therefore, there is a demand for improving the coating system.

### SUMMARY OF THE INVENTION

An object of the present invention is to provide a nozzle assembly that can spray a fluid such as glue, especially polyurethane glue, onto a substrate with high precision, thereby achieving an extremely thin coating layer. Furthermore, the present invention also provides a coating system comprising the nozzle assembly.

According to the present invention, a nozzle assembly is provided, comprising: a lip plate that has a lip plate channel extending through the lip plate in a thickness direction of the lip plate and a receiving groove located on one side of the lip plate in the thickness direction and used for receiving a fluid from outside of the nozzle assembly, the lip plate channel and the receiving groove being in fluid communication with each other; a cover plate that is connected to the lip plate on the other side of the lip plate opposite to the receiving groove; and a shim that is located between the lip plate and the cover plate, wherein the shim has a cutout extending upwards from a bottom side of the shim, and a height of a topmost portion of the cutout is greater than or equal to a height of a topmost portion of the lip plate channel of the lip plate.

In this way, the thickness and width of the fluid distributed from the nozzle assembly can be controlled precisely and stably, thereby enabling the acquisition of a coating of the desired thickness, especially an extremely thin or even micron-level coating layer, on the substrate.

Preferably, the cutout has a rectangular shape, the lip plate channel has a rectangular cross-section, and a height of a top edge of the cutout is greater than or equal to a height of a top edge of the lip plate channel. Thus, it can be ensured that the fluid flows out continuously.

Preferably, a top edge of the cutout is provided with a structured configuration. Thus, a specific fluid pattern can be achieved.

Preferably, the structured configuration is a comb-like configuration. Thus, a specific fluid pattern, particularly a striped pattern, can be achieved.

Preferably, the shim has a thickness in a range of 0.05-0.2 mm. Thus, a coating layer of a specific thickness can be achieved.

Preferably, the cutout of the shim has a width in a range of 4-20 mm. Thus, a coating layer of a specific width can be achieved.

Preferably, the cutout of the shim has a width of 7 mm. Thus, a coating layer of a specified width can be achieved.

Preferably, the lip plate, the cover plate and the shim have the same profile in a plane perpendicular to the thickness direction of the lip plate. This makes it easy to manufacture.

Preferably, the lip plate, the cover plate and the shim have protrusions at bottom portions, respectively, and the cutout is located in the protrusion of the shim. This makes it easy to manufacture and to observe the state of a fluid outlet.

Preferably, the cover plate, the shim and the lip plate are sequentially fixed together by screws.

According to the present invention, a coating system is also provided, comprising: a fluid source; a metering assembly that is in the form of a positive displacement pump and configured to be in fluid communication with the fluid source to receive a fluid therefrom; and the aforementioned nozzle assembly that is in fluid communication with the metering assembly to receive a fluid from the metering assembly and to distribute the fluid out of the nozzle assembly.

In this way, the thickness and width of the fluid distributed from the coating system can be controlled precisely and stably, thereby enabling the acquisition of a coating layer of the desired thickness, especially an extremely thin or even micron-level coating, on the substrate.

Preferably, the fluid source is configured as one of a fluid cartridge and a hose, and the coating system has a universal adapter for connecting the fluid cartridge or the hose. Thus, the fluid can be replaced quickly.

Preferably, the metering assembly includes a driving gear driven by a motor and a driven gear. Thus, the fluid can be distributed precisely.

Preferably, a gap between the driving gear and the driven gear on one side of the metering assembly is in fluid communication with the fluid source, and a gap between the driving gear and the driven gear on the other side of the metering assembly is in in fluid communication with the nozzle assembly.

Preferably, the coating system has a heating block, via which the metering assembly is in fluid communication with the nozzle assembly. Thus, the fluid can be heated precisely to facilitate smooth fluid distribution.

Preferably, the heating block has a flange portion and a body portion connected to each other, the metering assembly is installed on the body portion, and the nozzle assembly is installed on the flange portion.

Preferably, the coating system comprises a valve integrated with the heating block. Thus, the distribution of the fluid can be controlled.

Preferably, the valve and the nozzle assembly at least partially overlap in a vertical direction of the coating system. Thus, the fluid in a fluid channel can be back-sucked when the system is shut down, thereby eliminating a fluid hammerhead.

Preferably, a valve seat is provided in a fluid channel in the flange portion, and a top end of a valve stem of the valve can abut against the valve seat, thereby blocking a fluid flow in the fluid channel in the flange portion.

Preferably, a seal is provided between the lip plate of the nozzle assembly and the heating block, the seal having a central opening.

The present application further discloses use of a coating system for surface coating of a thin sheet battery.

Preferably, the thin sheet battery is a battery for powering an electric vehicle.

The nozzle assembly and the coating system of the present invention can achieve an extremely thin adhesive thickness, for example, less than 20 μm, thereby meeting the spraying requirement on a battery surface of the electric vehicle.

### BRIEF DESCRIPTION OF THE DRAWINGS

These and other objects and advantages of the present invention will become apparent more fully from the following description taken in conjunction with the drawings, wherein the same reference signs are used throughout the drawings to indicate the same or similar components, and wherein:

FIG. 1 is a perspective view of a coating system comprising a nozzle assembly according to the present invention;

FIG. 2 is a longitudinal sectional view of the coating system comprising a nozzle assembly according to the present invention;

FIG. 3 is an enlarged sectional view of a nozzle assembly area of the coating system according to the present invention;

FIG. 4 is an exploded view of a metering assembly of the coating system according to the present invention; and

FIG. 5 is an exploded view of the coating system according to the present invention.

### DETAILED DESCRIPTION OF THE EMBODIMENTS

Hereinafter, embodiments according to the present invention will be described in detail with reference to the drawings. In the description of the drawings, the same or corresponding parts are indicated by the same numerals and symbols, and repeated explanations will be omitted. In the following description, the terms indicating directions, such as “up”, “down”, “front”, “back”, “top”, and “bottom” (if any), are used solely for describing the drawings and do not constitute substantial limitations to the present invention. Other examples can be used, and other modifications can be made, without departing from the spirit or scope of the subject matter presented herein. It will be readily understood that the aspects of the present disclosure, as generally described herein and illustrated in the drawings, can be arranged, replaced, combined, and designed in various different configurations, each of which is explicitly conceived and forms a part of the present disclosure.

When a component or its variant is described as being “connected to”, “coupled to”, or “installed to” another component, it can be directly connected, coupled, or installed to that other component, or there may be an intermediate component involved. Conversely, when a component or its variant is described as being “directly connected”, “directly coupled”, or “directly installed” to another component, there is no intermediate component involved. Throughout the text, the same reference signs indicate the same components. As used herein, the singular forms “a/an” and “the” are also intended to include the plural forms as well, unless the context clearly indicates otherwise. For the sake of brevity and/or clarity, well-known functions or constructions may not be described in detail. The term “and/or” and its abbreviation “/” include any combination and all combinations of one or more related listed items.

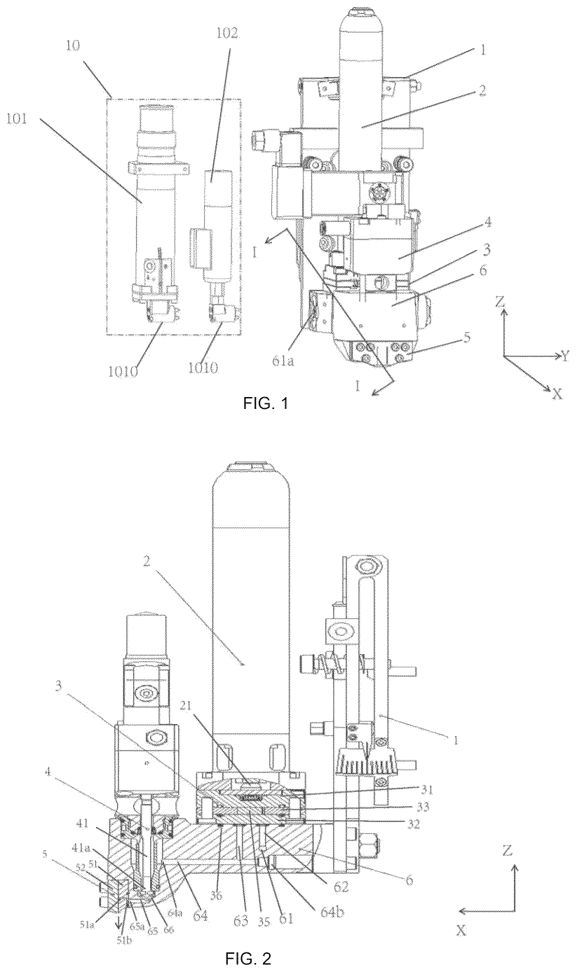

FIG. 1 is a perspective view of a coating system comprising a nozzle assembly according to the present invention. Note that, in the figure, the direction X indicates a longitudinal or length direction of the coating system, the direction Y indicates a transverse or width direction of the coating system, and the direction Z indicates a vertical, up-down or height direction of the coating system. Note that, in the present Description, the longitudinal direction, transverse direction and vertical direction of the coating system can be simply referred to as the longitudinal direction, transverse direction and vertical direction, respectively.

As shown in FIG. 1, the coating system comprises a fluid source 10, a metering assembly 3, and a nozzle assembly 5. The fluid source 10 is used to accommodate and/or supply a fluid. The fluid source is, for example, a cartridge 101 or a hose 102. The cartridge 101 may be of various specifications, for example, a 300 cc cartridge. In some examples, the fluid may be an adhesive, such as a polyurethane adhesive, a thermoplastic hot-melt adhesive, a pressure-sensitive adhesive, or another adhesive with sufficient cohesive strength and “exposure time” as described herein, but other materials can also be considered. Instead of using a cartridge, a hose or other connecting pipes can be used. The hose or other connecting pipes are directly connected to another metering system. The hose can be connected to a melter. A hot fluid, such as a hot adhesive, is supplied to the coating system either through the connection of the melter and the hose or through the direct connection of an adhesive cartridge. The cartridge or hose is used to supply a fluid such as molten glue. The cartridge or hose, as an alternative fluid supply device, is very convenient to implement, thereby increasing the adaptability of the coating system to the fluid source 10. The fluids suitable for distribution are not limited to glue, but may be a variety of other fluid materials in the spraying process. The glue may be insulating glue or conductive glue. Generally, the conductive glue contains a conductive substance to facilitate conduction after being coated on the surface of a substrate.

The fluid source 10, for example, the cartridge 101 or hose 102, can be connected to a universal adapter 1010 of the coating system. These universal adapters can have the same construction. Therefore, the cartridge 101 or hose 102 can be connected to or in fluid communication with a coating system of the same specification or configuration or an interface of the same coating system via the universal adapter 1010. With the universal adapter 1010, different forms of fluid sources can be used, multiple fluids such as glue can be supplied, and the fluids can be quickly replaced in actual operation.

The metering assembly 3 is an integrated metering system, and has the form of a positive displacement pump. A miniature positive displacement pump/gear pump can deliver a very small amount of glue when rotating tooth by tooth, thereby enabling a fluid outflow rate to be controlled with relatively high precision, and the delivery amount is very precise. The metering assembly 3 receives a fluid from the fluid source 10. A drive device such as a servomotor 2 drives a shaft of the metering assembly 3/metering pump to rotate at a constant speed or variable speed. The rotational speed of the metering assembly 3 is precisely controlled so that the gear pump will provide a stable outflow flow. With the metering assembly 3, the fluid can be accurately and sufficiently delivered to a coating nozzle assembly 5. The metering assembly 3, in the form of a gear pump, plays an important role in the preparation of a micron-level coating fluid film, such as an adhesive film, and is an important factor in achieving micron-level coating performance.

The nozzle assembly 5 is located at the end of the coating system in a fluid flow direction. The nozzle assembly 5 has the form of a slit nozzle for coating a strip-shaped fluid coating layer on the substrate.

The metering assembly 3 can be directly connected to or in direct fluid communication with the nozzle assembly 5. Preferably, the coating system is provided with a heating block 6 located between the metering assembly 3 and the nozzle assembly 5. The heating block 6 has a plurality of fluid channels inside for fluid communication between the metering assembly 3 and the nozzle assembly 5. A seal 36 is provided between the heating block 6 and the metering assembly 3.

As shown in FIG. 1, the coating system is also provided with an adjusting mechanism 1. The adjusting mechanism 1, whose structure is not limited, may be a conventional adjusting mechanism with a winch. For example, the adjusting mechanism 1 is installed on the heating block 6 of the coating system. In the absence of the heating block 6, the adjusting mechanism 1 can be installed on a housing of the metering assembly 3 of the coating system. The adjusting mechanism 1 adjusts the height, levelness and elevation angle of the coating system, and, specifically, can adjust the positions in left-to-right and front-to-back directions, the tilt angle, and the height in a vertical direction of a wiper lip (fluid outlet/glue outlet) of the nozzle assembly 5, respectively. The coating system is also provided with a valve 4, which will be described later.

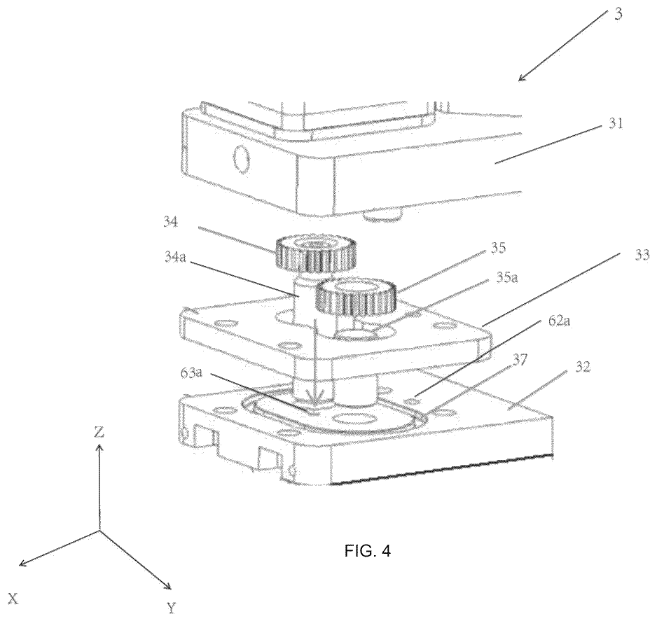

FIG. 2 is a longitudinal sectional view of the coating system comprising a nozzle assembly according to the present invention. The longitudinal section of the coating system shown in FIG. 2 is taken in a longitudinal direction X along a section line I-I in FIG. 1, which mainly illustrates the configuration of the fluid channels inside the coating system. As shown in FIG. 2, the adjusting mechanism 1 and the metering assembly 3 are respectively installed on the heating block 6 of the coating system. The metering assembly 3 comprises an upper plate 31, a lower plate 32, and a gear support plate 33 located between the upper plate and the lower plate. A miniature gear set of the metering assembly 3 is provided in the gear support plate 33, thereby constituting an internal metering pump. The gear set of the metering assembly 3 comprises a driving gear 34 (not shown here; please see FIG. 4) and a driven gear 35. The driving gear 34 is driven by a motor shaft 21 of the motor 2.

As shown in FIG. 2, the metering assembly 3 is in fluid communication with the heating block 6. Preferably, the heating block 6 has a first channel 61, a second channel 62, a third channel 63 and a fourth channel 64 in sequential fluid communication. As can be seen from FIG. 1, the first channel 61 has a heating block inlet port 61a, which is in fluid communication with the universal adapter 1010 connected to the fluid source. The second channel 62 is in fluid communication with an inlet port 62a in the metering assembly 3, and the third channel 63 is in fluid communication with an outlet port 63a in the metering assembly 3 (refer to FIG. 4). The fourth channel 64 is in fluid communication with the nozzle assembly 5. Thus, the fluid from the fluid source passes through the heating block 6, the metering assembly 3, and the heating block 6 in sequence and flows into the nozzle assembly 5. It is understandable that the number, cross-sectional shape and size of the fluid channels inside the heating block 6 are not particularly restricted.

The fourth channel 64 may be in direct fluid communication with the nozzle assembly 5. For example, the heating block 6 comprises a body portion and a flange portion, which are connected to each other or integrally formed. The metering assembly 3 is provided on the body portion of the heating block 6. The first channel 61, the second channel 62, the third channel 63 and the fourth channel 64 of the heating block 6 are basically provided in the body portion. The nozzle assembly 5 is provided on the flange portion. The fourth channel 64 is in direct fluid communication with the nozzle assembly 5.

However, it can be set that the fourth channel 64 is not in direct fluid communication with the nozzle assembly 5. For example, the valve 4 is provided on the flange portion and located between the fourth channel 64 and the nozzle assembly 5. The fourth channel 64 is in fluid communication with the nozzle assembly 5 via the valve 4.

Specifically, the valve 4 is installed on the flange portion from one side of the heating block 6 on which the metering assembly 3 is installed. The valve 4, of which the type is not specifically limited, may be, for example, an electromagnetic control valve. The valve 4 has a valve stem 41, which extends downwards in the flange portion beyond the fourth channel 64 of the heating block 6, that is, a top end 41a of the valve stem 41 is lower than the fourth channel 64 of the heating block 6, and, in particular, lower than a port 64a of the fourth channel 64. On the other hand, the heating block 6 has a fifth channel 65, which is in fluid communication with the fourth channel 64 of the heating block 6 via an inner cavity of the valve 4 that houses the valve stem 41. One end, specifically an inner end, of the fifth channel 65, which is in communication with the inner cavity of the valve 4, is provided with a valve seat 66, against which the top end 41a of the valve stem 41 can abut, thereby blocking fluid communication between the fifth channel 65 and the fourth channel 64. The valve 4 is provided between the nozzle assembly 5 and the heating block 6, and thus between the nozzle assembly 5 and the metering assembly 3.

Further, as can be seen from FIG. 2, the flange portion of the heating block 6 forms a part of the housing of the valve 4, in particular an underground housing. Thus, the valve 4 is an integrated valve that is integrated with the heating block 6. Moreover, when the coating system is shut down, the valve stem 41 of the valve 4 moves upwards, thereby sucking the fluid in the fifth channel 65 upwards/backwards, whereby the valve 4 has a back-suction effect, that is, the valve 4 constitutes a back-suction valve. The valve 4 cannot be simply regarded as a common on/off valve. The valve 4 expresses two main purposes in the present application. One purpose is the so-called back-suction valve, which has an important function of sucking back a fluid such as glue once the valve 4 is closed. Therefore, as long as the equipment stops coating, the back-suction valve 4 can eliminate a hammerhead defect of the coated fluid. On the other hand, the valve stem 41 of the valve 4 is deeply integrated into the heating block 6, and a closed end port of the valve 4 is adjacent to an inlet groove of the nozzle assembly 5. Due to this structure, there are many benefits for coating a fluid such as glue on the substrate. For instance, the start/stop function of the coating system is significantly improved because this construction enhances the system's responsiveness to start/stop commands.

As shown in FIG. 1, the fluid source 10 is arranged on one side of the motor 2 and the metering assembly 3 in the transverse direction Y of the coating system. As shown in FIG. 2, preferably, the adjusting mechanism 1, the motor 2, and the valve 4 are arranged sequentially in the longitudinal direction X of the coating system, and the valve 4 at least partially overlaps with the nozzle assembly 5 in the vertical direction Z of the coating system. It is well known that a hydraulic pressure drop inside the fluid channel/glue path has a significant negative impact on the final coating performance. According to the present embodiment, at least partially overlapping the valve 4 and the nozzle assembly 5 in the vertical direction Z of the coating system makes it possible to reduce a channel distance from the top end 41a of the valve stem 41 of the valve 4 to the nozzle assembly 5, thereby reducing the hydraulic pressure drop in the channel. Further, the metering assembly 3 is positioned as close as possible to the nozzle assembly 5 in the longitudinal direction X. Thus, the hydraulic pressure drop in the channel can be further reduced. This construction improves the responsiveness of the coating system to start/stop commands.

In addition, the heating block 6 is also provided with a plug to eliminate dead zones within the fluid channel/flow path so as to avoid a residual solidified fluid. For example, the heating block 6 is provided with a plug 64b, which is positioned at one end of the fourth channel 64 opposite to the port 64a, thereby closing the fourth channel 64 at that end. Preferably, a heating element and a temperature sensor are provided inside the heating block 6. The heating element is used to heat the fluid from the metering assembly 3, and the temperature sensor senses a temperature of the fluid inside the heating block 6. A channel path inside the heating block 6 is optimized to the shortest distance to reduce a fluid pressure drop generated in the channel.

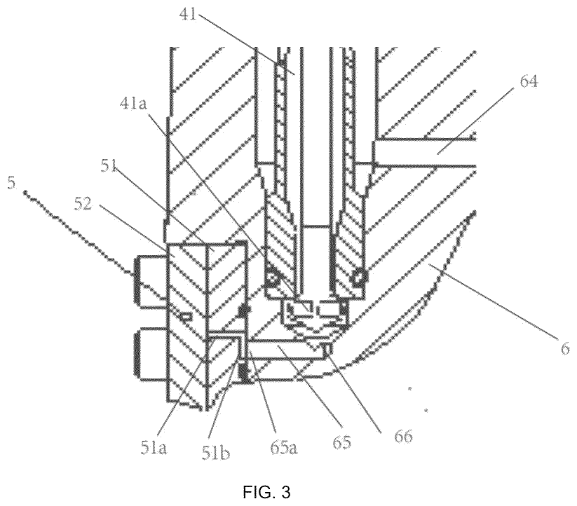

FIG. 3 is an enlarged sectional view of a nozzle assembly area of the coating system according to the present invention. As shown in FIGS. 2-3, the nozzle assembly 5 comprises a lip plate 51 and a cover plate 52. The lip plate 51 and the cover plate 52 are sequentially fixed together by screws. The lip plate 51 has a lip plate channel 51a extending through the lip plate in a thickness direction of the lip plate and a receiving groove 51b located on one side of the lip plate in the thickness direction and used for receiving a fluid from outside of the nozzle assembly. The lip plate channel 51a and the receiving groove 51b are in fluid communication with each other. When the heating block 6 is not provided, the receiving groove 51b can be provided to face an outlet port of the metering assembly 3 so as to receive the fluid from the metering assembly 3. When the heating block 6 is provided between the metering assembly 3 and the nozzle assembly 5, as shown in FIG. 3, the receiving groove 51b is located on one side of the lip plate 51 facing the fifth channel 65 of the heating block 6, and is in fluid communication with the fifth channel 65, specifically an outflow port 65a of the fifth channel 65.

The cover plate 52 is connected to the lip plate 51 on the other side of the lip plate 51 opposite to the receiving groove 51b. The fluid material can sequentially pass through the fifth channel 65 of the heating block 6, through the receiving groove 51b, and then through the lip plate channel 51a to reach a slit between the lip plate 51 and the cover plate 52. Thus, the nozzle assembly 5 forms a slit-type nozzle assembly.

FIG. 4 is an exploded view of a metering assembly of the coating system according to the present invention. As shown in FIG. 4, the driving gear 34 and the driven gear 35 constitute a gear set of the metering assembly 3. The gear set is installed in the gear support plate 33 located between the upper plate 31 and the lower plate 33. The driving gear 34 has a driving gear shaft 34a and is driven by a drive device, such as the motor 2, wherein the driving gear shaft 34a is drivingly connected to a driving shaft of the drive device, such as the motor shaft 21. The motor 2, which is, for example, a servomotor, can transmit a shaft speed and an output power precisely. The driven gear 35 has a driven gear shaft 35a. The driving gear 34 and the driven gear 35 constitute a miniature gear set. Specifically, a gap between the driving gear 34 and the driven gear 35 on one side of the metering assembly 3 is in fluid communication with the fluid source 10, and a gap between the driving gear 34 and the driven gear 35 on the other side of the metering assembly 3 is in in fluid communication with the nozzle assembly 5. Therefore, the internal space of the metering assembly 3 or metering pump is in fluid communication with the fluid source 10, thereby enabling the reception of a fluid material from the fluid source 10. The nozzle assembly 5 is in fluid communication with the metering assembly 3, thereby enabling the reception of a fluid material from the metering assembly 3. The fluid material passes through the metering assembly 3 and then enters the nozzle assembly 5.

Further, a groove 37 can be provided on an upper surface of the lower plate 32 to accommodate a sealing component (not shown here; please see FIG. 2), which is provided between the lower plate 32 and the gear support plate 33 to prevent unintended leakage of the fluid between them.

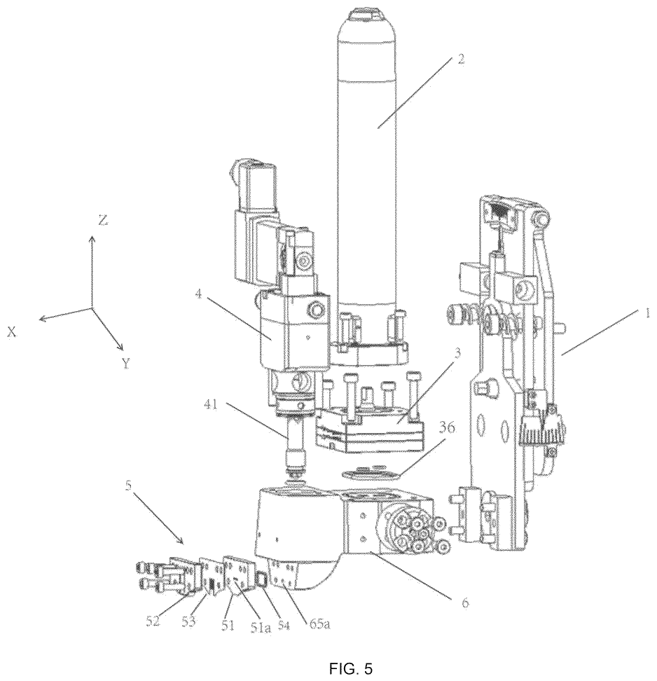

FIG. 5 is an exploded view of the coating system according to the present invention. As can be seen from FIG. 5, in addition to the lip plate 51 and the cover plate 52, the nozzle assembly 5 also comprises a shim 53 that is located between the lip plate 51 and the cover plate 52. The shim 53 has a cutout 53a extending upwards from a bottom side of the shim, and a height of a topmost portion of the cutout is greater than or equal to a height of a topmost portion of the lip plate channel 51a of the lip plate 51. Preferably, the cutout 53a has a roughly rectangular shape, and the lip plate channel 51a has a rectangular cross-section. A height of a top edge of the rectangular cutout 53a is greater than or equal to a height of a top edge of the lip plate channel 51a with the rectangular cross-section. A shim-type slit nozzle assembly 5, which is designed in combination, is another important factor in achieving micron-level coating performance.

The shape of the top edge of the cutout 53a can be set as required. Preferably, the top edge of the cutout 53a has a structured configuration to form a specific fluid pattern when coated by the coating system. In particular, the structured configuration may be a comb-like configuration to form a textured fluid pattern.

In the field of power batteries for electric vehicles, there is usually a need to coat a fluid such as a hot-melt adhesive on an aluminum foil at an edge of the electrode substrate of the battery. For this application, an equivalent adhesive film width is between about 4 mm and about 12 mm, with an adhesive width of 7 mm generally preferred, and the required adhesive film thickness is about 0.05-0.2 mm. Exceeding this specified range is not permitted. Accordingly, the thickness of the shim 53 is set to be in a range of 0.05-0.2 mm. The width of the shim 53 is set to be in a range of 4-20 mm, preferably 7 mm. It can be understood that other values can be selected for the width and thickness of the shim 53 according to actual production needs. A nozzle shim made of stainless steel is used to provide more freedom to manipulate the coating of patterns and the distribution of results. For instance, the thickness of the shim can be adjusted within a range of 0.01-0.2 mm or even larger, to control the thickness of the adhesive film. Meanwhile, the cutout construction/pattern in the shim is a main method for managing coating consistency and uniformity.

The profiles of the lip plate 51, the cover plate 52 and the shim 53 are not particularly limited. Preferably, the profiles of the lip plate 51, the cover plate 52 and the shim 53 are consistent and/or the same in a plane perpendicular to the thickness direction of the lip plate 51. Preferably, as shown in FIG. 5, the lip plate 51, the cover plate 52 and the shim 53 have protrusions at bottom portions, respectively, and the cutout 53a is located in the protrusion of the shim 53. Thus, the nozzle assembly has a protruding spray lip.

The connection between the lip plate 51, the cover plate 52 and the shim 53 of the nozzle assembly 5, as well as the connection between the nozzle assembly 5 and the heating block 6, can be achieved in a variety of ways. Preferably, the nozzle assembly 5 and the heating block 6 are connected by a plurality of screws, and the nozzle assembly 5 and the heating block 6 and metering assembly 3 are fixed together and in fluid communication with each other.

Referring again to FIG. 5, a seal 54 is provided between the lip plate 51 of the nozzle assembly 5 and a joining surface of the flange portion of the heating block 6. The seal 54 is annular, preferably rectangular, in shape, i.e., having a central opening. The seal 54 surrounds a fluid flowing from the heating block 6 to the nozzle assembly 5, specifically the lip plate 51 of the nozzle assembly 5. The outflow port 65a of the fifth channel 65 of the heating block 6 is set to be lower than a height of the lip plate channel 51a of the lip plate 51 in the vertical direction Z of the coating system, and, specifically, lower than a height of the lowest portion of the lip plate channel 51a of the lip plate 51. Thus, the portion below the lip plate channel 51a of the lip plate 51 constitutes a dam member. The dam member extends upwards from the bottom of the lip plate 51 to the lip plate channel 51a. The top edge of the dam member is higher than the outflow port 65a of the fifth channel 65 of the heating block 6. Thereby, when the fluid flows out from the outflow port 65a of the fifth channel 65 of the heating block 6, it enters the receiving groove 51b of the lip plate 51 and then flows upwards, and when the fluid rises to the height of the dam member, it flows into the lip plate channel 51a. Owing to the presence of the dam member, the distribution flow of the fluid can be precisely controlled, and the occurrence of a fluid hammerhead can be suppressed.

The outer edge of the lip plate 51 on one side surface connected to the seal 54 can be provided with a boss (not shown) to restrict the movement of the seal 54. It can be conceived that, instead of being provided on the surface of the lip plate 51, the boss can be provided on a surface of the flange portion that is in contact with the seal 54.

The various components of the coating system can be formed of the same material. Preferably, each component can be made of an aluminum alloy. Moreover, weight reduction holes can be provided on the components to lower the overall weight of the system.

The assembly of the coating system of the present invention is described below. The coating system of the present invention can be divided into multiple subsystems, and is obtained by assembling these subsystems. First, install the motor 2 and the metering assembly 3 together to thereby form a first subsystem; install the pump 4 and the nozzle assembly 5 on the heating block 6 to thereby form a second subsystem; install the first subsystem on the second subsystem to thereby form a third subsystem; install the adjusting mechanism 1 on the heating block 6 to thereby form a fourth subsystem; and then connect the fluid source 10 to the heating block 6, so as to form the entire coating system. It is easy to understand that the assembly order of the components can be changed freely. Preferably, the fluid source 10 is installed last, but this is not necessary.

The operating principles of the coating system of the present invention are described below.

When an operator or a control device of the coating system issues a start command to start the coating system, the fluid flowing out of the fluid source 10 enters the heating block 6. The fluid enters the first channel 61 and the second channel 62 of the heating block 6 and then enters the metering assembly 3. Driven by the motor 2, the fluid is transported out of the metering assembly 3 by a gear set of the metering assembly 3, i.e., a high-precision metering pump, into the third channel 63 and the fourth channel 64 of the heating block 6, and then into the inner chamber of the valve 4. When the valve 4 is turned on or the valve stem 41 of the valve 4 is raised, the fluid flowing out of the inner cavity of the valve 4 enters the fifth channel 65 of the heating block 6 (please see FIG. 2); then, the fluid flowing out of the fifth channel 65 passes through the seal 54 into the receiving groove 51b of the lip plate 51 of the nozzle assembly 5, and is blocked by the dam member of the lip plate 51 to rise. Afterwards, the fluid flows over the dam member into the lip plate channel 51a, enters between the lip plate 51 and the cover plate 52, and finally flows out of the nozzle assembly 5 via the cutout 53a of the shim 53 to be distributed onto the surface of a workpiece or substrate, such as a battery electrode. Thus, the coating system utilizes a slit-type nozzle assembly with a shim to coat an extremely thin (micron-level) fluid with a predetermined width, such as glue, onto the substrate. The coating system of the present invention, which can also be called a belt-type coater, incorporates a uniquely designed, combined (shim+slit) nozzle assembly.

Jetting and spraying are the most important non-contact methods for adhering glue to any type of substrate. Unfortunately, neither jetting nor spraying can form a uniform and continuous glue mold. At present, a slit nozzle coating solution is the only way to meet such an application requirement. The slit nozzle coating uses a contact method to distribute the glue onto the electrode in some way. The fluid distribution can be achieved as long as the hot adhesive material can continuously flow to the end of the slit nozzle assembly.

From the perspective of fluid flow channels and working principles, the design concept of the present invention is obviously different from that of any previous slit coating nozzle. The novel design of the combined slit nozzle assembly of the present invention is a prominent improvement based on the common slit nozzle structure, such as the addition of a shim and the combination with a dam structure, which reduce glue dripping during system standby. The coating system of the present invention, which integrates a shim and a precision metering pump and uses a high-precision metering pump to precisely supply a fluid such as glue to the shim-type slit coating nozzle, achieves high-precision coating performance (capable of forming a continuous glue layer of 0.05-0.2 mm on the electrode aluminum foil), provides a supply unit for a variety of hot fluids such as glue, offers various types of fluid patterns, provides friendly human-machine interface interaction, and has reliable and durable spare parts that are easy to maintain. Furthermore, the coating system of the present invention supports high-speed production lines of automated production lines. The coating system of the present invention is particularly suitable for coating thin terminal-side edges of the blade batteries.

The specific embodiments of the present invention have been described in detail above with reference to the drawings. It can be expected that various variations and modifications can be made to the present invention without departing from the spirit and scope of the present invention as defined by the appended claims.

### LIST OF REFERENCE SIGNS

1 adjusting mechanism
2 motor
3 metering assembly
33 gear support plate
34 driving gear
35 driven gear
4 valve
5 nozzle assembly
51 lip plate
51a lip plate channel
51b receiving groove
52 cover plate
54 seal
6 heating block
10 fluid source
101 cartridge
102 hose

1. A nozzle assembly comprising:
a lip plate that has a lip plate channel extending through the lip plate in a thickness direction of the lip plate and a receiving groove located on one side of the lip plate in the thickness direction and used for receiving a fluid from outside of the nozzle assembly, the lip plate channel and the receiving groove being in fluid communication with each other;
a cover plate that is connected to the lip plate on the other side of the lip plate opposite to the receiving groove; and
a shim that is located between the lip plate and the cover plate,
wherein the shim has a cutout extending upwards from a bottom side of the shim, and a height of a topmost portion of the cutout is greater than or equal to a height of a topmost portion of the lip plate channel of the lip plate.

2. The nozzle assembly according to claim 1, wherein the cutout has a rectangular shape, the lip plate channel has a rectangular cross-section, and a height of a top edge of the cutout is greater than or equal to a height of a top edge of the lip plate channel.

3. The nozzle assembly according to claim 1, wherein a top edge of the cutout is provided with a structured configuration.

4. The nozzle assembly of claim 3, wherein the structured configuration is a comb-like configuration.

5. The nozzle assembly according to claim 1, wherein the shim has a thickness in a range of 0.05-0.2 mm.

6. The nozzle assembly according to claim 1, wherein the cutout of the shim has a width in a range of 4-20 mm.

7. The nozzle assembly according to claim 6, wherein the cutout of the shim has a width of 7 mm.

8. The nozzle assembly according to claim 1, wherein the lip plate, the cover plate and the shim have the same profile in a plane perpendicular to the thickness direction of the lip plate.

9. The nozzle assembly according to claim 8, wherein the lip plate, the cover plate and the shim have protrusions at bottom portions, respectively, and the cutout is located in the protrusion of the shim.

10. The nozzle assembly according to claim 1, wherein the cover plate, the shim and the lip plate are sequentially fixed together by screws.

11. A coating system characterized by comprising:
a fluid source;
a metering assembly that is in the form of a positive displacement pump and configured to be in fluid communication with the fluid source to receive a fluid therefrom; and
the nozzle assembly according to claim 1 that is in fluid communication with the metering assembly to receive a fluid from the metering assembly and to distribute the fluid out of the nozzle assembly.

12. The coating system of claim 11, wherein the fluid source is configured as one of a fluid cartridge and a hose, and
the coating system has a universal adapter for connecting the fluid cartridge or the hose.

13. The coating system according to claim 11, wherein the metering assembly includes a driving gear driven by a motor and a driven gear.

14. The coating system according to claim 13, wherein a gap between the driving gear and the driven gear on one side of the metering assembly is in fluid communication with the fluid source, and a gap between the driving gear and the driven gear on the other side of the metering assembly is in in fluid communication with the nozzle assembly.

15. The coating system according to claim 11, wherein the coating system has a heating block, via which the metering assembly is in fluid communication with the nozzle assembly.

16. The coating system according to claim 15, wherein the heating block has a flange portion and a body portion connected to each other, the metering assembly is installed on the body portion, and the nozzle assembly is installed on the flange portion.

17. The coating system according to claim 16, wherein the coating system comprises a valve integrated with the heating block.

18. The coating system according to claim 17, wherein the valve and the nozzle assembly at least partially overlap in a vertical direction of the coating system.

19. The coating system according to claim 17, wherein a valve seat is provided in a fluid channel in the flange portion, and
a top end of a valve stem of the valve can abut against the valve seat, thereby blocking a fluid flow in the fluid channel in the heating block.

20. The coating system according to claim 15, wherein a seal is provided between the lip plate of the nozzle assembly and the heating block, the seal having a central opening.
